(19) United States
(12) Patent Application Publication
(10) Pub. No.: US 2016/0085185 A1
(43) Pub. Date: Mar. 24, 2016

(54) IMAGE FORMING APPARATUS

(71) Applicant: CANON KABUSHIKI KAISHA, Tokyo (JP)

(72) Inventor: Hiroki TAKAYANAGI, Abiko-shi (JP)

(21) Appl. No.: 14/855,690

(22) Filed: Sep. 16, 2015

(30) Foreign Application Priority Data
Sep. 19, 2014 (JP) 2014-190919

(51) Int. Cl. G03G 15/16; G03G 15/00

(52) U.S. Cl. CPC G03G 15/1665; G03G 15/556

(57) ABSTRACT

When density of a first patch does not fall within a target density, a control portion forms a first patch again by increasing a development contrast and a second patch without changing a development contrast. If the first patch formed again does not fall within the target density, densities of the second patches formed without changing the development contrast are compared. The density of the first patch formed again does not fall within the target density because a non-electrostatic adhesion has been generated in toner or a toner charge amount has increased. Then, it is determined whether or not the non-electrostatic adhesion has been generated based on the comparison of the densities of the second patches formed without changing the development contrast. If a difference of the densities of the second patches is small, a primary transfer current is increased by assuming that the non-electrostatic adhesion has been generated.

### BACKGROUND OF THE INVENTION

1. Field of the Invention

The present invention relates to an electro-photographic image forming apparatus such as a copier, a printer, a facsimile, a multi-function printer, or the like and more specifically to an image forming apparatus forming an image while adjusting image density.

2. Description of the Related Art

As an image forming apparatus, there is known an intermediate transfer type image forming apparatus in which a toner image is primarily transferred from a photosensitive drum to an intermediate transfer belt and is then secondarily transferred from the intermediate transfer belt to a recording medium for example. For such an image forming apparatus, there is known a technology of forming an adjustment toner image (referred to as a ‘patch’ hereinafter) of predetermined density on the photosensitive drum and the intermediate transfer belt, of detecting the density of the patch, and of feeding back the density to image forming condition as disclosed in Japanese Patent Application Laid-open No. 2003-202711 for example.

Conventionally, intensity of a laser beam irradiated to the photosensitive drum to form an electrostatic latent image thereon is controlled so as to increase a toner amount on the photosensitive drum when the patch density is thin and to lessen the toner amount on the photosensitive drum when the patch density is thick in contrary. Adjustment of the density of an image formed on the recording medium is thus made.

Lately, it is contemplated to increase processing speed to improve productivity and others, and temperature of a fixing unit in melting and fixing a toner image on the recording medium is set high. If the temperature of the fixing unit is actually increased, temperature of a vicinity of a primary transfer portion (primary transfer nip portion) where the toner image is transferred from the photosensitive drum to the intermediate transfer belt increases by being affected by heat radiated from the fixing unit. If the temperature in the vicinity of the primary transfer portion increases, the toner on the photosensitive drum becomes inseparable from the photosensitive drum because adhesion of the toner increases by being affected by wax and others contained in the toner (referred to ‘non-electrostatic adhesion’ hereinafter). This situation may cause a defective image having uneven density or the like. However, it is difficult to correctly adjust the density of the image even by controlling the intensity of the laser beam irradiated to the photosensitive drum when the non-electrostatic adhesion of the toner increases. That is, it is difficult to eliminate the defective image caused by the toner whose non-electrostatic adhesion has increased.

### SUMMARY OF THE INVENTION

According to one aspect of the invention, an image forming apparatus includes an image bearing member; a charging portion charging the image bearing member; a developing portion developing the electrostatic latent image formed on the image bearing member by toner by applying a developing bias; a transfer body forming a transfer portion, transferring a toner image formed on the image bearing member, with the image bearing member by being in contact with the image bearing member; a transfer bias applying portion applying a transfer bias to the transfer portion; a density detecting portion detecting density of the toner image on the transfer body; and a control portion executing a first mode of forming a first adjustment toner image and a second adjustment toner image whose density is lower than that of the first adjustment toner image on the image bearing member, and of detecting the densities of the first and second adjustment toner images transferred to the transfer body, and a second mode of forming a third adjustment toner image and a fourth adjustment toner image after executing the first mode and forming a predetermined number of images in a case where the density of the first adjustment toner image detected in the first mode is lower than a reference density, and of detecting densities of the third and fourth adjustment toner images transferred to the transfer body. The control portion forms the third adjustment toner image by increasing a development contrast, which is a potential difference between an exposure potential of the image bearing member exposed by the exposure portion and the developing bias, more than that generated in the case that the first adjustment toner image has been formed, and forms the fourth adjustment toner image in a same image forming condition with that of the second adjustment toner image. The control portion increases the transfer bias in a case where certain conditions are met more than that in a case where those conditions are not met where the certain conditions are the density of the third adjustment toner image detected in the second mode being lower than the reference density, the density of the fourth adjustment toner image being less than a predetermined value, and a difference of the densities of the second and fourth adjustment toner images falling within a predetermined range.

According to a second aspect of the invention, an image forming apparatus includes an image bearing member; a charging portion charging the image bearing member; a developing portion developing the electrostatic latent image formed on the image bearing member by toner by applying a developing bias; a transfer body forming a transfer portion, transferring a toner image formed on the ibmage bearing member, with the image bearing member by being in contact with the image bearing member; a transfer bias applying portion applying a transfer bias to the transfer portion; a density detecting portion detecting density of the toner image on the transfer body; and a control portion executing a first mode of forming a first adjustment toner image and a second adjustment toner image whose density is lower than that of the first adjustment toner image on the image bearing member, and of detecting the densities of the first and second adjustment toner images transferred to the transfer body, and a second mode of forming a third adjustment toner image and a fourth adjustment toner image after executing the first mode and forming a predetermined number of images in a case where the density of the first adjustment toner image detected in the first mode is lower than a reference density, and of detecting densities of the third and fourth adjustment toner images transferred to the transfer body. The control portion forms the third adjustment toner image by increasing a development contrast, which is a potential difference between an exposure potential of the image bearing member exposed by the exposure portion and the developing bias, more than that generated in the case that the first adjustment toner image has been formed, and forms the fourth adjustment toner image in a same image forming condition with that of the second adjustment toner image. The control portion increases the transfer bias in a case where certain conditions are met more than that in a case where those conditions are not met where the certain conditions are the density of the third adjustment toner image detected in the second mode being lower than the density of the first adjustment toner image or a difference of the densities of the first and third adjustment toner images falling within a predetermined range, the density of the fourth adjustment toner image being less than a predetermined value, and a difference of the densities of the second and fourth adjustment toner images falling within a predetermined range.

Further features of the present invention will become apparent from the following description of exemplary embodiments with reference to the attached drawings.

### BRIEF DESCRIPTION OF THE DRAWINGS

FIG. 1 is a schematic diagram illustrating a configuration of an image forming apparatus according to a first embodiment of the invention.

FIG. 2 is a block diagram of a control system of the image forming apparatus.

FIG. 3 is a flowchart of an image density adjustment control.

FIG. 4A is a schematic diagram illustrating a first patch.

FIG. 4B is a schematic diagram illustrating a second patch

FIG. 5 is a graph showing a relationship between transfer current and transfer residual density.

FIG. 6 is a graph illustrating the image density adjustment control.

FIG. 7 is a diagrammatic perspective view illustrating disposition of density detecting sensors.

FIG. 8 is a schematic diagram illustrating a configuration of an image forming apparatus according to a second embodiment of the invention.

### DESCRIPTION OF THE EMBODIMENTS

### First Embodiment

### Image Forming Apparatus

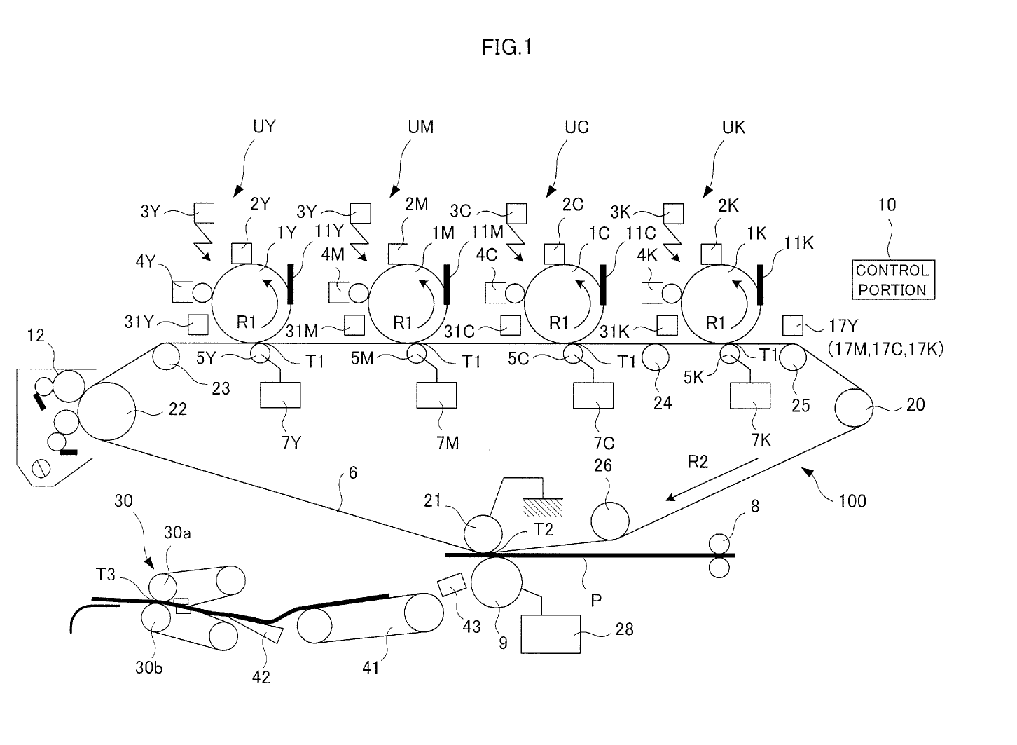

A schematic configuration of an image forming apparatus according to a first embodiment of the invention will be described with reference to FIG. 1. The image forming apparatus 100 shown in FIG. 1 is a tandem intermediate transfer type full-color printer in which a plurality of image forming portions UY, UM, UC, and UK is disposed along an intermediate transfer belt 6, i.e., an intermediate transfer body.

In the image forming portion UY, a yellow toner image is formed on a photosensitive drum 1Y and is then primarily transferred onto the intermediate transfer belt 6. In the image forming portion UM, a magenta toner image is formed on a photosensitive drum 1M and is then primarily transferred onto the intermediate transfer belt 6. In the image forming portions UC and UK, cyan and black toner images are formed respectively on photosensitive drums 1C and 1K and are then primarily transferred onto the intermediate transfer belt 6. The four color toner images primarily transferred onto the intermediate transfer belt 6 are conveyed to a secondary transfer portion T2 and are secondarily transferred collectively on a recording medium P (sheet member such as a sheet of paper, an OHP sheet, or the like).

The image forming portions UY, UM, UC, and UK are constructed substantially in the manner except that the colors of toners used in developing units 4Y, 4M, 4C, and 4K are different as yellow, magenta, cyan, and black. Accordingly, the image forming portion UY of yellow will be typically described in the following description, and the other image forming portions UM, UC, and UK will be described by replacing Y, i.e., a subscript of the reference sign, with M, C, and K.

The image forming portion UY includes a primary charger 2Y, an exposure unit 3Y, a developing unit 4Y, a transfer charger 5Y, a drum cleaning unit 11Y, and a temperature detecting sensor 31Y, respectively disposed around the photosensitive drum (photosensitive body) 1Y, i.e., an image bearing member. The photosensitive drum 1Y includes a photosensitive layer formed on an outer circumferential surface of a cylinder made of aluminum and rotates in a direction of an arrow R1 in FIG. 1 with a predetermined processing speed.

The primary charger 2Y is a charging roller or a scorotron corona charger formed into a roller shape and charges a surface of the photosensitive drum 1Y with homogeneous negative dark part potential. The exposure unit 3Y generates a laser beam, in which scan line image data obtained by developing a color separation image of each color is ON-OFF modulated, from a laser emitting device and scans the laser beam by a rotating mirror to form an electrostatic latent image of the image on the charged photosensitive drum 1Y. The developing unit 4Y supplies toner to the photosensitive drum 1Y to develop the electrostatic latent image as a toner image. Developer containing toner and carrier is circulatedly conveyed within the developing unit 4Y. The developer is replenished to the developing unit 4Y from a developer replenishing unit not shown.

The transfer charger 5Y is a primary transfer roller formed into a roller shape, is disposed to face the photosensitive drum 1Y while interposing the intermediate transfer belt 6 between them, and forms a primary transfer portion T1 of the toner image between the photosensitive drum 1Y and the intermediate transfer belt 6. A primary transfer bias, e.g., +1 to +5 kV, is applied to the transfer charger 5Y by a primary transfer bias power source 7Y, i.e., a primary bias applying portion, in the primary transfer portion T1. In response to the application, a primary transfer current flows in the primary transfer portion T1 and the toner image is primarily transferred from the photosensitive drum 1Y to the intermediate transfer belt 6. The temperature detecting sensor 31Y, i.e., a temperature detecting portion, detects temperature in a vicinity of the primary transfer portion T1. The drum cleaning unit 11Y recovers primary transfer residual toner left on the photosensitive drum 1Y after the primary transfer by rubbing a cleaning blade on the photosensitive drum 1Y. According to the present embodiment, the transfer body forming the transfer portion transferring the toner image formed on the image bearing member between the image bearing member and the intermediate transfer belt 6 in contact with the image bearing member is thus constructed by the intermediate transfer belt 6. Still further, the transfer bias applying portion applying the transfer bias to the transfer portion is constructed by the primary transfer portion T1.

The intermediate transfer belt 6 is stretched around and supported by a tension roller 20, a secondary transfer inner roller 21, a driving roller 22, and a number of other tension rollers 23 through 26 and rotates by being driven by the driving roller 22 in a direction of an arrow R2 in FIG. 1 with speed of 150 to 360 mm/sec. for example. A secondary transfer portion T2 is a toner image transfer nip portion transferring the toner image onto a recording medium P and formed by bringing a secondary transfer outer roller 9, i.e., a secondary transfer member, into contact with the intermediate transfer belt 6 stretched by the secondary transfer inner roller 21. In the secondary transfer portion T2, a secondary transfer bias, e.g., +1 to +7 kV, is applied to the secondary transfer outer roller 9 by a secondary transfer bias power source 28, i.e., a secondary bias applying portion. In response to the application of the bias, a secondary transfer current flows in the secondary transfer portion T2 and the toner image is secondarily transferred from the intermediate transfer belt onto the recording medium P conveyed to the secondary transfer portion T2. At this time, a registration roller 8 conveys the recording medium P to the secondary transfer portion T2 in synchronism with a passage of the toner image primarily transferred to the intermediate transfer belt 6 passing through the secondary transfer portion T2. A belt cleaning unit 12 recovers secondary transfer residual toner left while adhering on the intermediate transfer belt 6 after the secondary transfer by rubbing the intermediate transfer belt 6.

The recording medium P onto which the four color toner image has been transferred by the secondary transfer portion T2 is conveyed to a fixing unit 30 by a secondary transfer post-guide 43 and a pre-fixing conveying unit 41. The pre-fixing conveying unit 41, i.e., a conveying portion, includes an endless belt member formed of rubber material such as EPDM with 100 to 110 mm in width and 1 to 3 mm in thickness. The belt member rotates while carrying the recording medium P. The belt member is provided with a large number of holes of 3 to 7 mm in diameter to suction the recording medium P through the holes from an inside of the pre-fixing conveying unit 41. Thereby, the recording medium P is conveyed to the fixing unit 30 while being securely held by the pre-fixing conveying unit 41 by high carrying power.

In the fixing unit 30, a fixing nip portion T3 is formed of fixing rollers 30a and 30b being in contact with each other and fixes the toner image onto the recording medium P while conveying the recording medium P. That is, the fixing nip portion T3 is formed in the fixing unit 30 by bringing the fixing roller 30b in pressure contact with the fixing roller 30a heated from an inside thereof by a lamp heater or the like not shown to temperature of 150 to 180° C. for example. The toner image is fixed to the recording medium P as the recording medium P undergoes heat and pressure by being nipped and conveyed through the fixing nip portion T3. The recording medium P on which the toner image has been fixed by the fixing unit 30 is discharged out of the apparatus.

Still further, the image forming apparatus 100 of the present embodiment is provided with a density detecting sensor 17Y downstream, in the rotation direction of the intermediate transfer belt 6, of the respective image forming portions UY through UK. The density detecting sensor 17Y, i.e., the density detecting portion, detects density of an adjustment toner image (referred to simply as a ‘patch’ hereinafter) transferred from the photosensitive drum 1Y onto the intermediate transfer belt 6 (onto the intermediate transfer body).

The intermediate transfer belt 6 is a belt member endlessly formed and having a base, an elastic layer, and a surface layer in order from an inner circumferential side thereof. The base is formed of resin such as polyimide and polycarbonate or of various rubbers containing an adequate amount of carbon black as a charge preventing agent in thickness of 0.05 to 0.15 mm for example. The elastic layer is formed of various rubbers such as CR rubber and urethane rubber containing an adequate amount of carbon black as a charge preventing agent in thickness of 0.1 to 0.5 mm for example. The surface layer is formed of resin such as urethane resin and fluorine resin in thickness of 0.0005 to 0.02 mm. For instance, the intermediate transfer belt 6 used here is type 94i, manufactured by Heidon Corporation, whose resistivity is 5E+8 to 1E+14 [Ω·cm] (23° C., 50% RH), MD1 hardness is 60 to 85° (23° C., 50% RH), and static coefficient of friction is 0.15 to 0.6 (23° C., 50% RH).

The transfer charger 5Y is what an elastic layer of ion conductive foam rubber is formed around an outer circumference of a cylindrical core metal. For instance, one whose outer diameter is 15 to 20 mm and a resistance value measured in normal temperature and humidity (23° C., 50% RH) by applying 2 kV is 1 E+5 to 1E+8Ω is used. A secondary transfer outer roller 9 is what an elastic layer of ion conductive foam rubber is formed around an outer circumference of a cylindrical core metal. For instance, one whose outer diameter is 20 to 25 mm and a resistance value measured in normal temperature and humidity (23° C., 50% RH) by applying 2 kV is 1E+5 to 1E+8Ω is used. A secondary transfer inner roller 21 is what an elastic layer of electron conductive rubber is formed around an outer circumference of a cylindrical core metal. For instance, one whose outer diameter is 18 to 22 mm and a resistance value measured in normal temperature and humidity (23° C., 50% RH) by applying 50 V is 1E+5 to 1E+8Ω is used.

### <Two-Component Developer>

Two-component developer containing toner (non-magnetic) having a negative charging property and carrier having a positive charging property is used as the developer in the developing unit 4Y. Here, the two-component developer will be described.

The toner includes coloring resin particles containing a binding resin such as styrene resin and polyester resin, a coloring agent such as carbon black, die, and pigment, and other additive agents as necessary, and coloring particles into which external additive such as colloidal silica fine powder is externally added. A volume average particle size of the toner is preferable to be 4 to 10 μm because it becomes hard for the toner to cause friction with the carrier and it becomes hard to control a charge amount if the particle size is too small and it becomes unable to form a toner image finely if the particle size is too large. It is more preferable to be 8 μm or less. Still further, toner whose melting point is low or toner whose glass transition point is low, e.g., 70° C., is used lately to improve fixability. Still further, toner containing wax is used to improve separability after fixation. Therefore, the non-electrostatic adhesion is liable to increase by being affected by the wax or the like in a case when temperature in a vicinity of the primary transfer portion rises by receiving radiant heat from the fixing unit 30.

For the carrier, metals such as surface oxidized or unoxidized iron, nickel, cobalt, manganese chrome, and rare-earth element and their alloys, or oxide ferrite may be suitably used. A manufacturing method of those magnetic particles is not specifically limited. A volume average particle size of the carrier is 20 to 60 μm and is more preferably 30 to 50 μm. Resistivity of the carrier is preferable to be 10⁷ Ω·cm or more and is more preferable to be 10⁸ Ω·cm or more.

### <Control Portion>

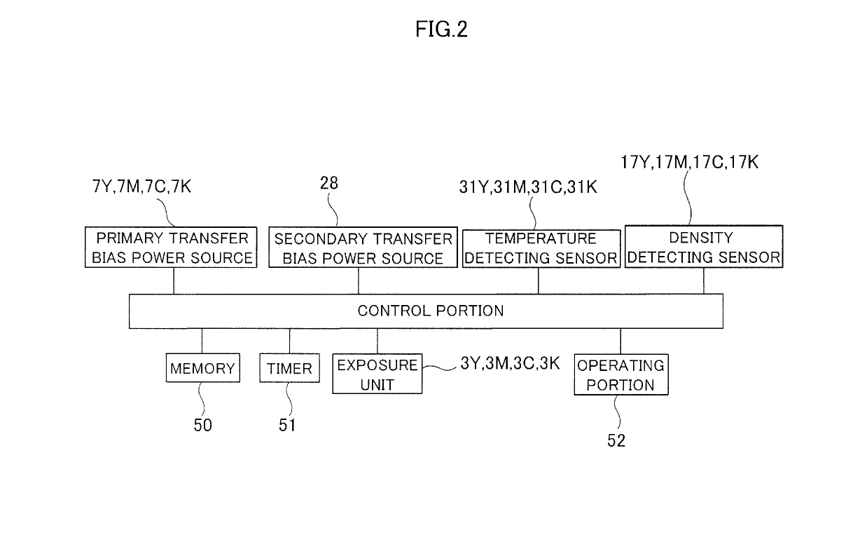

As shown in FIG. 1, the image forming apparatus 100 includes a control portion 10. The control portion 10 will be described with reference to FIG. 2. The control portion 10 is a CPU or the like executing various controls of the image forming apparatus 100 such as an image forming operation and includes a memory 50 and a timer 51 as shown in FIG. 2. The memory 50, i.e., a storage portion, includes a ROM, a RAM, and others and stores various programs, data, and others for controlling the image forming apparatus 100. The memory 50 can also temporarily store arithmetic processing results and others involved in the execution of the programs. The timer 51, i.e., a clocking portion, clocks an interrupt time in a timer interrupting process (interrupting process) and various times.

An operating portion 52 is an operation panel or an external terminal which is connected with the control portion 10 through an interface not shown and accepts an execution starting operation of the various programs such as an image forming job and inputs of various data made by a user.

Based on image data inputted from the operating portion 52, the control portion 10 executes various controls such as the image forming job (image forming program) and image density adjustment (image density adjustment program) stored in the memory 50. Based on the execution of these programs, the control portion 10 controls the exposure units 3Y through 3K, the primary transfer bias power sources 7Y through 7K, and a secondary transfer bias power source 28 connected through interfaces not shown. Although the control portion 10 can control various portions other than those described above, their description will be omitted here because it is not main object of the invention.

The control portion 10 controls the intensity of the laser beams (referred to as ‘LPWR’ hereinafter) of the exposure units 3Y through 3K irradiated in forming the electrostatic latent images on the photosensitive drums 1Y through 1K. Each of the exposure units 3Y through 3K is controlled to irradiate the LPWR of a predetermined strength associated in advance with a toner charge amount. A development contrast (Vcont) which is a potential difference between an exposure potential of the exposed photosensitive drums 1Y through 1K and a developing bias (Vdc) of the developing units 4Y through 4K varies by controlling the LPWR. For instance, the development contrast (Vcont) varies by changing the LPWR as shown in Table 1. The greater the development contrast (Vcont), the more the toner amount supplied from the developing units 4Y through 4K to the photosensitive drums 1Y through 1K increases as long as a toner charge amount of the developer circulately conveyed within the developing units 4Y through 4K. In this case, density of the toner image formed on the photosensitive drums 1Y through 1K increases.

TABLE 1

| LPWR | 80 | 92 | 104 | 116 | 128 | 140 | 152 | 164 | 176 | 188 | 200 |
|---|---|---|---|---|---|---|---|---|---|---|---|
| Vcont | 318~322 | 334~338 | 350~354 | 366~370 | 382~386 | 398~402 | 414~418 | 430~434 | 446~450 | 462~466 | 478~482 |

The control portion 10 also controls voltage (primary transfer bias) of the primary transfer bias power sources 7Y through 7K applied to the transfer chargers 5Y through 5K to transfer the toner images on the photosensitive drums 1Y through 1K to the intermediate transfer belt 6. The primary transfer bias power sources 7Y through 7K are controlled so as to apply the primary transfer bias of a voltage value enabling the transfer current associated in advance with the toner charge amount to flow to the primary transfer portion T1. In general, the control portion 10 performs the control of the primary transfer bias together with the control of the LPWR as an image forming condition. For instance, the control portion increases the LPWR and the primary transfer bias in response to an increase of the toner charge amount and lowers the LPWR and the primary transfer bias in response to a decrease of the toner charge amount. Still further, according to the present embodiment, the control portion 10 increases the primary transfer bias even if the toner charge amount barely changes in a case when the non-electrostatic adhesion is generated. This operation will be described later. It is noted that the control portion 10 can also control voltage (secondary transfer bias) of the secondary transfer bias power source 28 applied to the secondary transfer outer roller 9 to transfer the toner image on the intermediate transfer belt 6 to the recording medium P.

The control portion 10 is connected with the density detecting sensors 17Y through 17K and the temperature detecting sensors 31Y through 31K through interfaces not shown. The control portion 10 obtains density of the respective color patches of yellow, magenta, cyan, and black transferred onto the intermediate transfer belt 6 from the density detecting sensors 17Y through 17K. The control portion 10 also obtains temperature in the vicinity of the primary transfer portion T1 formed between the photosensitive drums 1Y through 1K and the intermediate transfer belt 6 from the temperature detecting sensors 31Y through 31K.

### <Image Density Adjusting Control>

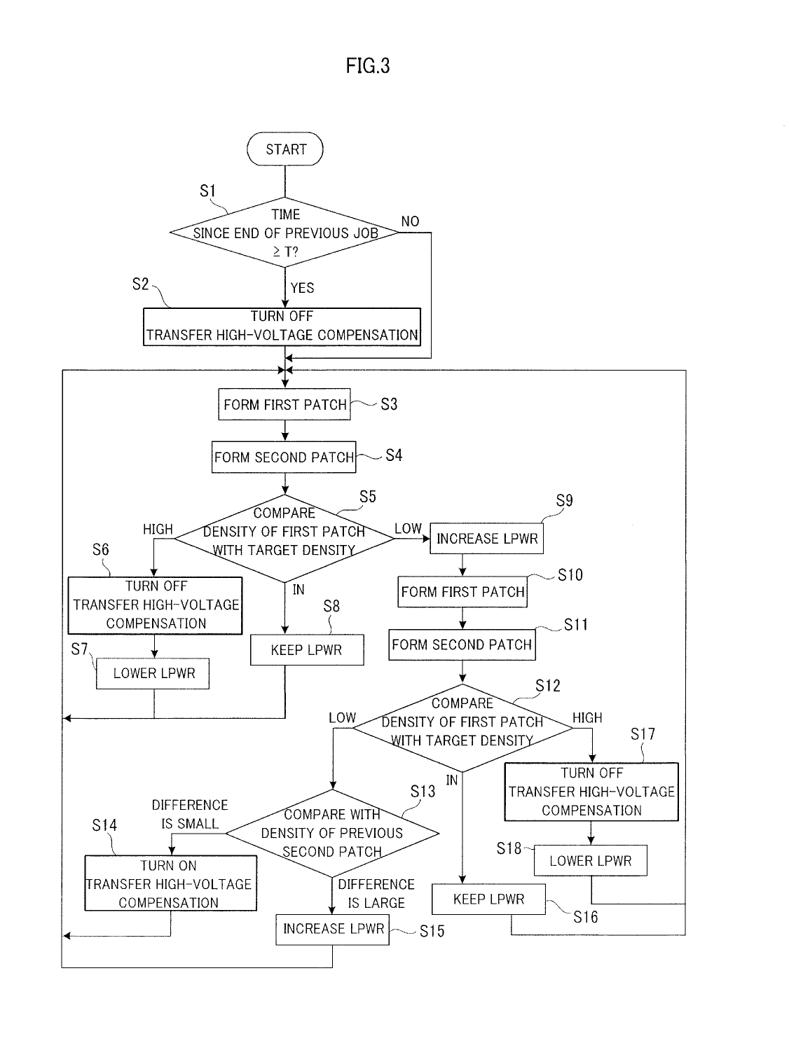

Next, an image density adjusting control executed by the control portion 10 will be described with reference to FIGS. 3 through 6. FIG. 3 is a flowchart illustrating the image density adjusting control. In the image density adjusting control, the LPWR and the primary transfer bias are controlled as image forming conditions. It is noted that while the image density adjusting control illustrated in FIG. 3 is executed per each image forming portions UY, UM, UC, and UK, the image forming portion UY will be exemplified here for convenience of the description. The controls on the other image forming portions UM, UC, and UK may be understood just by replacing the subscript Y of the reference sign within the description with M, C, and K.

The image density adjusting control is started in response to a start of the image forming job made by the control portion 10 and ends in response to an end of the image forming job. Here, the image forming job is a series of operations from a start to a completion of an image forming operation based on a print signal for forming the image on the recording medium. That is, the image forming job is the series of operations from a start of a preliminary operation (so-called a pre-rotating operation) required in executing the image forming operation to a completion of operations (so-called post-rotation operation) required in ending the image forming operation through image forming process. Specifically, the image forming job refers to a period from the pre-rotation time (preliminary operation before forming an image) after receiving the print signal (input of the image forming job) until the post-rotation (operation after forming the image). The image forming job includes a period of forming the image and a period between image forming operations when images are consecutively formed.

As shown in FIG. 3, the control portion 10 judges whether or not a predetermined time or more, e.g., T=30 minutes, has elapsed since an end of a previous image forming job in Step S1. If the predetermined time or more has not elapsed since the end of the previous image forming job, i.e., No in Step S1, the control portion 10 does not execute a control (see Step S2) of turning OFF a transfer high-voltage compensation described later. That is, if the transfer high-voltage compensation described later is already ON (see Step S14), the control portion 10 operates the image forming job of this time while keeping the transfer high-voltage compensation ON continuously. The condition in which the transfer high-voltage compensation is ON means that the primary transfer bias is increased (compensated) to a voltage (voltage flowing a transfer current B described later) higher than a predetermined voltage (voltage flowing a transfer current A described later). The condition in which the transfer high-voltage compensation is turned OFF means that the primary transfer bias is lowered (or returned to one before the compensation) from the voltage (the voltage flowing the transfer current B described later) higher than that of the predetermined voltage (the voltage flowing the transfer current A described later) to the predetermined voltage.

In a case when the predetermined time or more has elapsed since the end of the previous image forming job, i.e., Yes in Step S1, and if the transfer high-voltage compensation is already ON, the control portion 10 turns OFF the transfer high-voltage compensation in Step S2. If the transfer high-voltage compensation is already OFF at this time, the control portion 10 takes no specific action. That is, if 30 minutes or more has elapsed since the end of the previous image forming job for example, temperature within the apparatus body which has risen along with the execution of the image forming job drops. Then, temperature in the vicinity of the primary transfer portion T1 is stabilized to temperature, e.g., 28 to 32° C., which is lower than that during the image forming operation, so that the non-electrostatic adhesion of the toner is hardly generated by heat. If no non-electrostatic adhesion of the toner is generated, it is not necessary to increase the primary transfer bias to a voltage higher than the predetermined voltage because the adjustment of the image density can be made by controlling the LPWR. Then, in the case when the transfer high-voltage compensation is already ON, i.e., in the case where the primary transfer bias has been increased in the previous image forming job, the primary transfer bias is lowered to the predetermined voltage before executing a first mode described later.

The control portion 10 executes the first mode (control) shown in Steps S3 and S4 every time when the image forming job being executed forms a predetermined number of images, e.g., 25 to 85 sheets. That is, the control portion forms first and second patches on the intermediate transfer belt 6 in Steps S3 and S4. Then, the control portion 10 obtains densities of the first patch, i.e., a first adjustment toner image, and of the second patch, i.e., a second adjustment toner image, from the density detecting sensor 17Y and stores them in the memory 50.

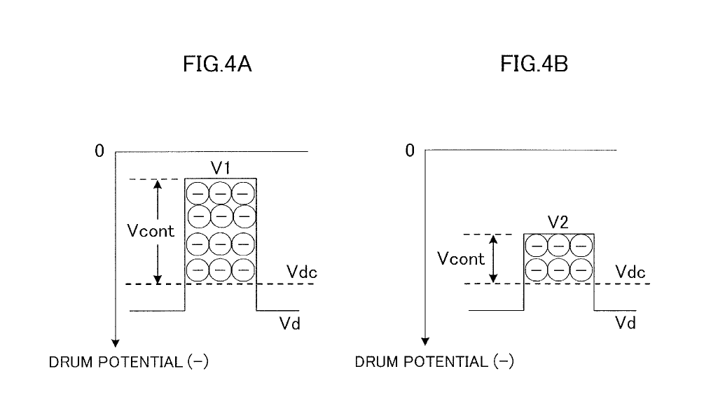

Here, the first patch will be described with reference to FIG. 4A. FIG. 4A is a schematic diagram illustrating potential of the photosensitive drum 1Y for explaining the first patch. Firstly, the control portion 10 controls the primary charger 2Y to homogeneously charge the photosensitive drum 1Y with a surface potential (Vd). The surface potential (Vd) is −800 to −1000 V for example. Next, the control portion 10 controls the LPWR of the exposure unit 3Y to form an electrostatic latent image of an exposure potential V1 on the photosensitive drum 1Y. Thereby, a development contrast (Vcont) is generated between the exposure potential V1 and a developing bias (Vdc) of the developing unit 4Y, so that the toner moves from the developing unit 4Y to the photosensitive drum 1Y and the toner image is developed. Then, the control portion 10 controls the primary transfer bias power source 7Y to transfer the toner image on the photosensitive drum 1Y onto the intermediate transfer belt 6. Thus, the first patch is formed on the intermediate transfer belt 6. It is noted that the first patch is formed into a size of 14 to 18 mm in length in a main scan direction (a direction of a rotational shaft of the photosensitive drum 1Y) and 21 to 25 mm in length in the rotation direction of the intermediate transfer belt 6 for example.

The second patch will be described with reference to FIG. 4B. FIG. 4B is a schematic diagram illustrating potential of the photosensitive drum 1Y for explaining the second patch. Firstly, the control portion 10 controls the primary charger 2Y to homogeneously charge the photosensitive drum 1Y with the surface potential (Vd). The surface potential (Vd) is −800 to −1000 V for example. Next, the control portion 10 controls the LPWR of the exposure unit 3Y to form an electrostatic latent image with an exposure potential V2 on the photosensitive drum 1Y. However, the exposure potential V2 is lower than the exposure potential V1, and the LPWR is set such that a development contrast (Vcont) generated between the exposure potential V2 and the developing bias (Vdc) of the developing unit 4Y becomes a constant value of 198 to 202 V for example. Then, the control portion 10 controls the primary transfer bias power source 7Y to transfer the toner image on the photosensitive drum 1Y onto the intermediate transfer belt 6. Thus, the second patch whose density is lower than that of the first patch is formed on the intermediate transfer belt 6. It is noted that the second patch is formed into a size of 20 to 25 mm in length in the main scan direction and 20 to 25 mm in length in the rotation direction of the intermediate transfer belt 6 for example.

The second patch whose density is lower than that of the first patch is formed because the second patch having the less density is less affected by the non-electrostatic adhesion of the toner during transfer. That is, because the photosensitive drum 1Y is in pressure contact with the intermediate transfer belt 6 with each other in the primary transfer portion T1, a pressure applied on the toner of the toner image formed on the photosensitive drum 1Y is possibly generated in the primary transfer portion T1. In the case when the non-electrostatic adhesion is generated in the toner, the toner is liable to stick and clump together by the pressure applied to the toner. Because the first patch whose density is higher contains a more toner amount as compared to the second patch whose density is low, the more toner possibly stick and clump together in the first patch. Then, an amount of toner left on the photosensitive drum 1Y without being transferred to the intermediate transfer belt 6 increases. In such a case, a great transfer current is required. Meanwhile, in forming the second patch whose density is lower, it is possible to transfer the most of toner of the toner image formed on the photosensitive drum 1Y onto the intermediate transfer belt 6 with less transfer current as compared to the transfer current required in forming the first patch. Therefore, it is possible to transfer the most of the toner even if the non-electrostatic adhesion is generated in the toner by the same amount of transfer current required in the case of the first patch. Then, the second patch is formed by maintaining the development contrast (Vcont) substantially constant as described above. Accordingly, the density of the second patch is unchangeable even if the non-electrostatic adhesion is generated in the toner and is changeable only when the toner charge amount changes. Still further, sensitivity to the change of the toner charge amount becomes high if the density is lower. It is because it is possible to obtain a large change of the density even if the change of the toner charge amount is small.

As described above, the second patch is formed by maintaining the development contrast (Vcont) substantially constant. Thereby, the density of the second patch indicates changes corresponding to the toner charge amount as shown in Table 2. That is, the density of the second patch can reflect the toner charge amount of the developer circulately conveyed within the developing unit 4Y. As it can be seen from Table 2, the lower the density of the second patch, the more the toner charge amount increases. It is noted that the density of the second patch here is 0.66 to 1.11 (measured by a density measuring instrument manufactured by XRite Corp.) in a case when the second patch is outputted to a recoding sheet GF-0081 (manufactured by Oji Paper Co. Ltd.). Table 2 also shows correspondence of the densities of the second patch and output values (signal values) of a second patch density detecting signal of the density detecting sensor 17Y.

Table 2 also shows correspondence between the transfer current A and the toner charge amount as a first Table and correspondence between the transfer current B and the toner charge amount as a second Table. The transfer current A set as a first control value is a primary transfer current flown when the transfer high-voltage compensation is not ON and the transfer current B set as a second control value is a primary transfer current flown when the transfer high-voltage compensation is ON. Each current value of these transfer currents A and B is determined in advance per density of the second patch, i.e., corresponding to the toner charge amount. That is, according to the present embodiment, the transfer current A corresponding to the toner charge amount is flown when the transfer high-voltage compensation is OFF, and the transfer current B corresponding to the toner charge amount is flown when the transfer high-voltage compensation is ON. Thus, the transfer currents A and B are variably controlled corresponding to the toner charge amount. It is because an optimal transfer current enabling to transfer the toner efficiently from the photosensitive drum 1Y to the intermediate transfer belt 6 is different corresponding to the toner charge amount. It is noted that the first and second Tables shown in Table 2 are stored in the memory 50 and are appropriately referred by the control portion 10.

TABLE 2

| | | | | | | |
|---|---|---|---|---|---|---|
| SECOND PATCH | 450~401 | 400~351 | 350~301 | 300~251 | 250~201 | 200~151 |
| DENSITY DETECTING | | | | | | |
| SIGNAL | | | | | | |
| SECOND PATCH | 1.11~1.06 | 1.05~0.99 | 0.98~0.92 | 0.91~0.84 | 0.83~0.75 | 0.74~0.66 |
| DENSITY | | | | | | |
| TONER CHARGE | 36~40 | 41~45 | 46~50 | 51~55 | 56~60 | 61~65 |
| AMOUNT μC/g | | | | | | |
| TRANSFER | 38~42 | 38~42 | 38~42 | 43~46 | 47~50 | 51~54 |
| CURRENT A μA | | | | | | |
| TRASNFER | 38~42 | 38~42 | 45~48 | 49~52 | 53~56 | 57~60 |
| CURRENT B μA | | | | | | |

Returning now to the description of FIG. 3, the control portion 10 compares the density of the first patch with a predetermined target density in Step S5. The target density, i.e., a reference density, is 1.56 to 1.65 (measured by the density measuring instrument manufactured by XRite Corp.) in the case when the first patch is outputted to a recoding sheet GF-0081 (manufactured by Oji Paper Co. Ltd.). Table 3 shows correspondence between the density of the first patch, i.e., 1.56 to 1.65, and output values (signal values) of a first patch density detection signal of the density detecting sensor 17Y.

TABLE 3

| | | | | | | | | | | |
|---|---|---|---|---|---|---|---|---|---|---|
| FIRST PATCH | 475~499 | 500~524 | 525~549 | 550~574 | 575~599 | 600~624 | 625~649 | 650~674 | 675~699 | 700~724 |
| DENSITY DETECTING | | | | | | | | | | |
| SIGNAL | | | | | | | | | | |
| FIRST PATCH | 1.36~1.4 | 1.41~1.45 | 1.46~1.5 | 1.51~1.55 | 1.56~1.6 | 1.61~1.65 | 1.66~1.7 | 1.71~1.75 | 1.76~1.8 | 1.81~1.85 |
| DENSITY | | | | | | | | | | |

In a case when the density of the first patch is higher than the predetermined density, i.e., HIGH in Step S5, and the transfer high-voltage compensation is ON, the control portion 10 turns OFF the transfer high-voltage compensation in Step S6 and lowers the LPWR corresponding to the density of the first patch in Step S7. Still further, the control portion 10 lowers the transfer current A corresponding to the density of the second patch. That is, it is possible to determine in this case that the toner charge amount has been simply reduced regardless whether or not the non-electrostatic adhesion of the toner is generated. For instance, in a case where the developer is replenished to the developing unit 4Y while forming an image, there may be case when the toner charge amount is lessened and the density of the first patch increases. In such a case, the control portion 10 turns OFF the transfer high-voltage compensation and also lowers the LPWR. Then, the control portion 10 returns to the process in Step S3 and lets the process stand by until when a predetermined number of images is formed by the image forming job being executed.

In a case when the density of the first patch falls within the predetermined target density, i.e., IN in Step S5, the control portion 10 returns to the process in Step S3 and lets the process stand by until when the image forming job being executed forms the predetermined number of images without executing the control of ON/OFF of the transfer high-voltage compensation and of increasing/decreasing the LPWR in Step S8. In this case, the control portion 10 executes also no control of increasing/decreasing the transfer current A. That is, because the desirable density is assured in this case, the control portion 10 executes the image forming job in the condition of the present moment without executing the controls of changing the LPWR and of turning ON/OFF the transfer high-voltage compensation that may change the density.

In a case when the density of the first patch is lower than the predetermined target density, i.e., LOW in Step S5, the control portion 10 executes a second mode (control) shown in Steps S9 through S11. That is, the control portion 10 increases the LPWR corresponding to the density of the first patch in Step S9. That is, it is unknown here why the density of the first patch is lower than the predetermined target density, i.e., whether it is because the non-electrostatic adhesion of the toner has increased or simply the toner charge amount has increased. Then, the control portion 10 increases the LPWR set in forming the first patch at first. Still further, because it is unable to distinguish whether or not the drop of the density of the first patch is caused by the non-electrostatic adhesion of the toner at this moment, setting of the transfer current is that of the transfer current A on which the transfer high-voltage compensation has not being executed, and the control portion 10 adjusts the transfer current A (increases for example) corresponding to the second patch density in the same manner with that of a normal time.

Then, after forming the predetermined number of images by the image forming job being executed after forming the first and second patches in Steps S3 and S4 described above, the control portion 10 forms again a first patch, i.e., a third adjustment toner image, (referred to as a ‘third patch’ hereinafter for convenience) on the intermediate transfer belt 6 in Step S10. Along with that, the control portion 10 forms a second patch, i.e., a fourth adjustment toner image, (referred to as a ‘fourth patch’ hereinafter for convenience) on the intermediate transfer belt 6 in Step S11. At this time, the control portion 10 increases the LPWR and changes the transfer current A (see FIG. 9) to form the third patch and forms the fourth patch without controlling the LPWR and the transfer current A. As described above, this is executed to be able to reflect the toner charge amount by the density of the fourth patch (second patch) by forming while maintaining the development contrast (Vcont) substantially constant. Then, the control portion 10 obtains the densities of the third and fourth patches from the density detecting sensor 17Y and stores them in the memory 50.

The control portion 10 compares the density of the first patch (third patch) formed again with the predetermined target density in Step S12. If the density of the third patch is higher than the predetermined target density, i.e., HIGH in Step S12, and if the transfer high-voltage compensation is already ON, the control portion 10 turns OFF the transfer high-voltage compensation in Step S17 and lowers the LPWR corresponding to the density of the third patch in Step S18. Still further, the control portion lowers the transfer current A corresponding to the density of the fourth patch. That is, if the density of the third patch becomes higher than the predetermined target density as a result of the increase of the LPWR in the process in Step S9 described above, it can be simply determined that the toner charge amount has become less. Then, the control portion 10 turns OFF the transfer high-voltage compensation and lowers the transfer current A. Then, the control portion 10 returns to the process in Step S3 and lets the process stand by until when the image forming job being executed forms the predetermined number of images.

If the density of the third patch falls within the predetermined target density, i.e., IN in Step S12, the control portion 10 returns to the process in Step S3 and lets the process stand by until when the image forming job being executed forms the predetermined number of images without controlling ON/OFF of the transfer high-voltage compensation and the increase/decrease of the LPWR in Step S16. That is, in this case, because the desirable density is secured as a result of the increase of the LPWR in the process of Step S9 described above, the control portion 10 continues the image forming job so as to form the predetermined number of images in the condition of the present moment without controlling ON/OFF of the transfer high-voltage compensation and the increase/decrease of the LPWR. In this case, the control portion 10 does not also control the increase/decrease of the transfer current A.

In a case when the density of the third patch is lower than a range of the target density, i.e., LOW in Step S12, the control portion 10 compares the density of the second patch (fourth patch) formed this time in Step S13 with the density of the second patch previously formed. That is, in a case when the density of the third patch is kept lower than the range of the target density regardless of the increase of the LPWR in Step S9 described above, it is conceivable to be caused by an increase of the toner charge amount or by an increase of the non-electrostatic adhesion of the toner. Then, the control portion 10 distinguishes here whether the toner charge amount has increased or the non-electrostatic adhesion of the toner has increased by comparing the densities of the second and fourth patches formed before and after the formation of the images on the predetermined number of recording media P.

In a case when a difference of the densities of the second and fourth patches is out of a predetermined range, i.e., the DIFFERENCE IS LARGE in Step S13, the control portion 10 increases the LPWR corresponding to the density of the third patch in Step S15. That is, if the non-electrostatic adhesion of the toner increases and the toner has become inseparable from the photosensitive drum 1Y, no large difference of the densities is generated in the second patch even if the density of the first patch formed again is kept low. Therefore, it can be determined that the toner charge amount has increased in this case. Then, the control portion 10 increases the LPWR. The control portion 10 also increases the transfer current A corresponding to the density of the fourth patch. For instance, if the density of the fourth patch (density of the second patch in Table 2) is 1.11 to 0.92 (toner charge amount is 36 to 50 μC/g) as shown in Table 2, the control portion 10 flows the transfer current A of 38 to 42 μA. If the density of the fourth patch is 0.91 or less (toner charge amount is 51 μC/g or more), the control portion 10 flows the transfer current A of 43 to 46, 47 to 50, and 51 to 54 μA. Then, the control portion 10 returns to the process in Step S3 and lets the process stand by until when the image forming job being executed forms the predetermined number of images.

In a case when the difference of the densities of the second and fourth patch is within a predetermined range, e.g., Δ50 or less in the second density detecting signal in Table 2, i.e., the DIFFERENCE IS SMALL in Step S13, the control portion 10 turns ON the transfer high-voltage compensation in Step S14. In this case, the control portion flows the transfer current B by which the primary transfer bias becomes higher voltage than the predetermined voltage when the toner charge amount is equal. That is, as shown in Table 2, the control portion 10 increases setting of the value of the transfer current with respect to the toner charge amount and flows the transfer current B corresponding to the density of the fourth patch. According to the present embodiment, the transfer current B which is higher than the transfer current A is flown in the case where the difference of the densities of the second and fourth patches is within the predetermined range and the density of the fourth patch is less than a predetermined value (less than 0.98). As shown in Table 2, the transfer current B of 45 to 48, 49 to 52, 53 to 56, and 57 to 60 μA are flown corresponding to the density of the fourth patch when the density of the fourth patch (density of the second patch in Table 2) is 0.98 or less (toner charge amount is 46 μC/g or more).

That is, if the toner charge amount has increased, not only the density of the third patch becomes lower than the target density, but also the difference of the densities of the second and fourth patches whose toner densities are low and which are more sensitive to the changes of the toner charge amount must be large. However, in this case, the condition that the difference of the densities of the second and fourth patches is small indicates that the toner charge amount has barely changed. Therefore, it can be determined that the density of the third patch is lower than the target density this time not because the toner charge amount has increased, but because the non-electrostatic adhesion of the toner has increased and the toner has become inseparable from the photosensitive drum 1Y. Then, the control portion controls the primary transfer bias power source 7Y to increase the primary transfer bias to a voltage higher than a predetermined voltage and to flow the transfer current B whose current value is higher than that of the transfer current A. This arrangement makes it possible to forcibly move the toner, which has become inseparable from the photosensitive drum 1Y due to the increase of the non-electrostatic adhesion, from the photosensitive drum 1Y to the intermediate transfer belt 6. Then, the control portion 10 returns to the process in Step S3 and lets the process stand by until when the image forming job being executed forms the predetermined number of images.

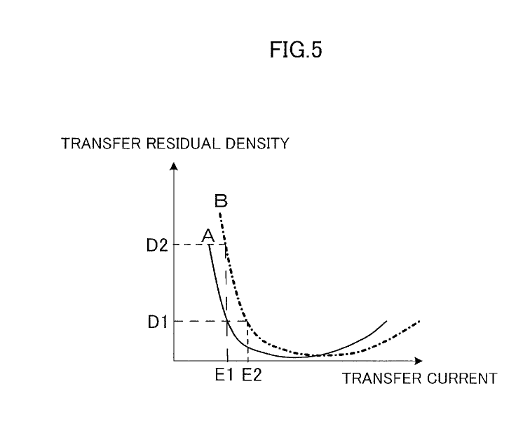

The transfer currents A and B flown to the primary transfer portion T1 corresponding to the control of the primary transfer bias power source 7Y will be described with reference to FIG. 5. FIG. 5 is a relationship among the transfer current A in the case when the non-electrostatic adhesion of the toner is small, the transfer current B in the case when the non-electrostatic adhesion of the toner is large, and a toner residual density, in the case when the toner charge amount is equal. Here, the toner residual density is density of the transfer residual toner left on the photosensitive drum 1Y without being transferred onto the intermediate transfer belt 6.

According to the present embodiment, the transfer current A is variably controlled corresponding to the toner charge amount. It is because the optimum transfer current is different depending on the toner charge amount as described above (see FIG. 2). However, in the case when the non-electrostatic adhesion of the toner increases and the transfer becomes unstable, the transfer current A flown to the primary transfer portion T1 (E1 in FIG. 5 for example) is compensated by the transfer current B (E2 in FIG. 5) whose current value is higher. That is, in this case, the non-electrostatic adhesion between the toner and the photosensitive drum 1Y becomes disturbance and the non-electrostatic adhesion among the toners also increases. Then, because the toner becomes inseparable from the photosensitive drum 1Y, a toner amount transferred onto the intermediate transfer belt 6 decreases if the current value E1 is flown as it is. That is, the toner residual density increases (D2 in FIG. 5) after the increase of the non-electrostatic adhesion of the toner as compared to one before the increase of the non-electrostatic adhesion of the toner (D1 in FIG. 5). The transfer current B whose current value is larger than that of the transfer current A is flown to avoid such condition. That is, it is possible to lower the toner residual density by flowing the transfer current B whose current value is larger than that of the transfer current A. Still further, if the non-electrostatic adhesion of the toner increases, the adhesion among the toners increases and the adhesion with the intermediate transfer belt 6 also increases. Accordingly, it is possible to delay an occurrence of such a phenomenon that the toner residual density increases again when the current value is increased just by separating the toner from the photosensitive drum 1Y by applying a transfer electric field strength higher than that of the transfer current A to the primary transfer portion T1 by flowing the transfer current B. Therefore, although the optimum transfer current is originally the transfer current A, it is preferable to flow the transfer current B when the non-electrostatic adhesion of the toner is generated.

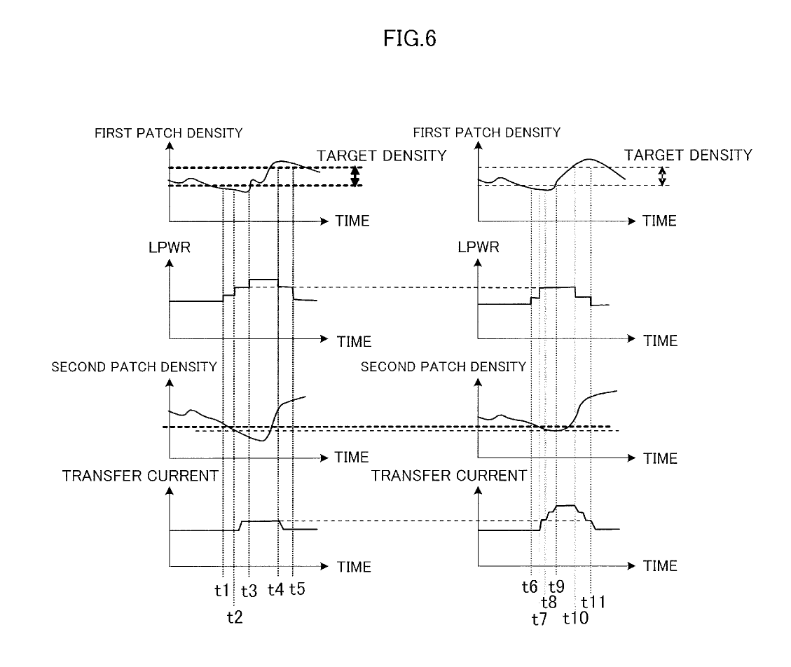

Each control of the LPWR and ON/OFF of the transfer high-voltage compensation in the image density adjusting control described above will be described with reference to FIG. 6. Graphs on a left side of FIG. 6 indicate a case when the non-electrostatic adhesion of the toner is small and graphs on a right side of FIG. 6 indicate a case when the non-electrostatic adhesion of the toner is large.

The case when the non-electrostatic adhesion of the toner is small will be described first. As indicated in the graphs on the left side of FIG. 6, the densities of the first and second patches are both lowered until times t1 through t3. That is, the toner charge amount increases along with formation of images. Then, the density of the first patch is out of the range of the target density. Therefore, the LPWR is increased in order to let the density of the first patch fall within the range of the target density. At this time, along with the increase of the toner charge amount, the LPWR is increased together with the transfer current A at time t2. During time t3 and time t4, the density of the first patch falls within the range of the target density. Therefore, it is not necessary to control ON/OFF of the transfer high-voltage compensation and the increase/decrease of the LPWR. Still further, because the LPWR has been increased at time t3, the density of the second patch reversely rises. Then, the density of the first patch becomes higher than the target density at time t4. That is, the toner charge amount is lessened. Then, in order to let the density of the first patch fall within the range of the target density, the LPWR as well as the transfer current A are lowered. Because the density of the first patch is still higher than the target density at time t5, the LPWR is lowered further.

The case when the non-electrostatic adhesion of the toner is large will be described. As shown in the graphs on the right side of FIG. 6, the same control at time t1 to time t2 executed to let the density of the first patch fall within the range of the target density is executed as for time t6 to time t7. That is, the LPWR as well as the transfer current A are increased at time t6 and time t7. However, ithe density of the first patch does not fall within the range of the target density on and after time t7 even if the LPWR is increased and changes of the density of the second patch is small. If the toner charge amount has been just increased along with the formation of images, not only the density of the first patch but also the density of the second patch must largely drop as shown in the graphs on the left side of FIG. 6. However, in this case, the density of the second patch does not largely drop (that is, the difference is small). Then, in this case, the control portion 10 determines that the density of the first patch has dropped due to the increase of the non-electrostatic adhesion of the toner and increases the transfer current stepwise to the current value of the transfer current B corresponding to the toner charge amount of this moment (time t8 to time t9). This point is a characteristic point of the present invention. For instance, in a case when the toner charge amount is 46 to 50 μC/g, the transfer current is increased from 38 to 42 μA (transfer current A) to 45 to 48 μA (transfer current B). In increasing the transfer current from 38 to 42 μA to 45 to 48 μA, it is increased stepwise like 43 to 44 μA and 45 to 48 μA for example. The transfer current is increased stepwise to minimize a difference of the densities otherwise appearing on the recording medium P before and after an abrupt change made in turning ON the transfer current compensation. It is noted that it is preferable to execute the control of the stepwise change of the transfer current in a non-image forming region (between sheets) between the recording medium P and a next recording medium P for example.

Then, after that, the density of the first patch is higher than the target density at time t10. Then, the control portion 10 turns OFF the transfer current compensation and lowers the transfer current to the current value of the transfer current A stepwise corresponding to the toner charge amount of this moment (time t10 to time t11). For instance, if the toner charge amount is 46 to 50 μC/g, the control portion 10 lowers the transfer current from 45 to 48 μA (transfer current B) to 38 to 42 μA (transfer current A). It is noted that the transfer current is lowered stepwise between the sheets in lowering the transfer current by turning OFF the transfer current compensation. At time t11, the density of the first patch is still kept higher than the target density. Then, the LPWR is lowered and the transfer current A is lowered to a current value corresponding to the toner charge amount at time t11.

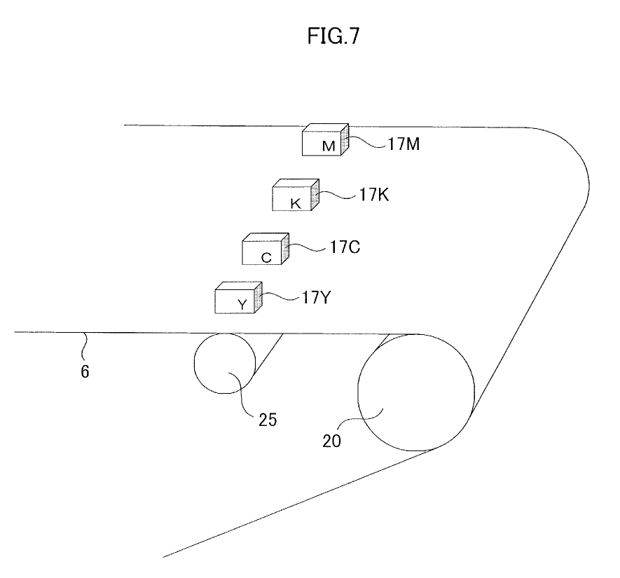

Next, an arrangement relation of the density detecting sensors 17Y through 17K in the main scan direction (the direction of the rotary shaft of the stretch roller 25) will be described with reference to FIG. 7. As shown in FIG. 7, the density detecting sensors 17Y through 17K are arranged in parallel in the direction of the rotary shaft of the stretch roller 25 so as to be able to detect the respective patches formed on the intermediate transfer belt 6 by the photosensitive drums 1Y through 1K (see FIG. 1). However, the density detecting sensors 17Y and 17M detecting the densities of the patched formed by the photosensitive drums 1Y and 1M (see FIG. 1) are disposed at edge sides of the intermediate transfer belt 6. In other words, the photosensitive drums 1Y and 1M (first image bearing members) on the side close to the fixing unit 30 (upstream in the rotation direction of the intermediate transfer belt 6) form the patches on end parts of the intermediate transfer belt 6. The photosensitive drums 1C and 1K (first image bearing members) on the side far from the fixing unit 30 (downstream in the rotation direction of the intermediate transfer belt 6) form the patches on center parts of the intermediate transfer belt 6. The density detecting sensors 17Y through 17K are disposed at positions facing those patches to be able to detect the densities of the patches formed at the end and center parts of the intermediate transfer belt 6. It is because the heat from the fixing unit 30 (see FIG. 1) extends not only to the primary transfer portion T1 but also to the both end parts of the intermediate transfer belt 6, and temperature of the both end parts of the intermediate transfer belt 6 may become higher than that of the center part. Due to that, the non-electrostatic adhesion of the toner is liable to be increased at the both end parts of the intermediate transfer belt 6. Therefore, the patches are formed on the end parts of the intermediate transfer belt 6 by the photosensitive drums 1Y and 1M on the side close to the fixing unit 30, and the densities of the patches are detected by the density detecting sensors 17Y and 17M in order to more correctly catch the influence of the non-electrostatic adhesion of the toner on the transfer.

As described above, it is determined whether or not the non-electrostatic adhesion has generated in the toner based on the comparisons of the densities of the first patch (third patch) formed by changing the development contrast and of the second patch (fourth patch) formed without changing the development contrast. That is, it is determined whether or not the non-electrostatic adhesion has been generated in the toner based on the comparison of the densities of the first and third adjustment toner images formed by changing the development contrast and the comparison of densities of the second and fourth adjustment toner images formed without changing the development contrast. A reason why the density of the third patch does not fall yet within the target density in the same manner with the first patch regardless that the third patch has been formed by changing the development contrast is because the toner charge amount has increased or the non-electrostatic adhesion of the toner has been generated. Then, it is determined that the non-electrostatic adhesion has been generated in the toner if the density of the third patch does not fall within the target density and the density of the fourth patch formed without changing the development contrast has barely changed from the density of the second patch. If the toner charge amount has increased, the density of the fourth patch formed without changing the development contrast must be thinner than the density of the second patch, i.e., a difference of the densities must be generated. However, if the density of the fourth patch has barely changed from the density of the second patch, it does not mean that the toner charge amount has increased and if so, it is considered that the non-electrostatic adhesion has been generated in the toner. Because the non-electrostatic adhesion is generated in the toner, the density of the third patch does not fall within the target density, and the density of the fourth patch barely changes from the density of the second patch. Then, in the case when the non-electrostatic adhesion is generated in the toner, the primary transfer bias is increased. This arrangement makes it possible to forcibly move the toner adhering on the photosensitive drum by the non-electrostatic adhesion and to hardly generate a defective image by the toner whose non-electrostatic adhesion has increased.

### Second Embodiment

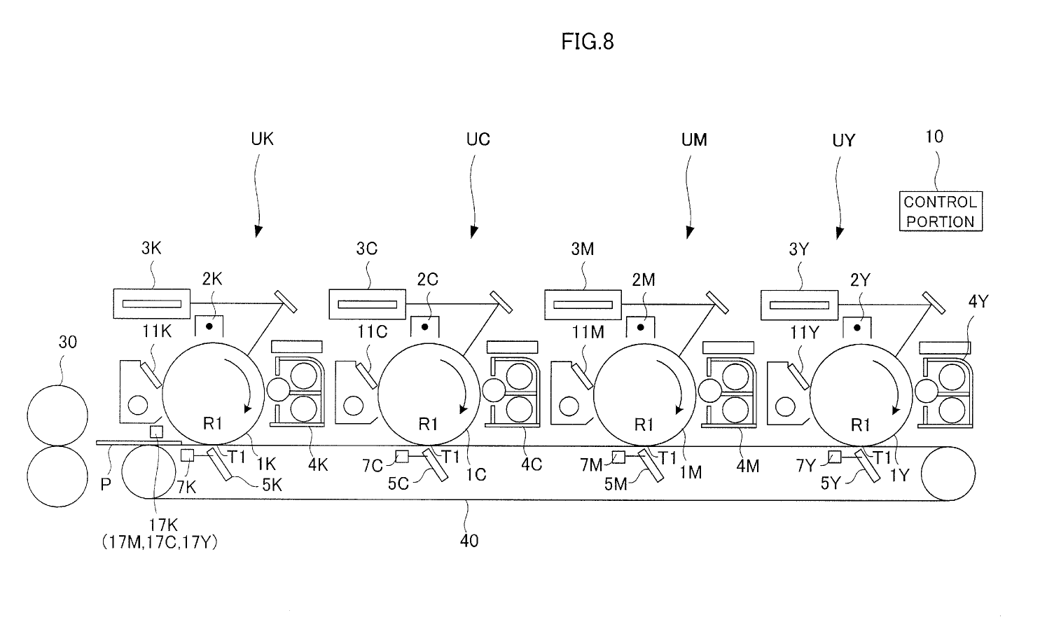

While the image forming apparatus 100 configured to secondarily transfer the respective color composite toner images collectively on the recording medium P after primarily transferring the respective color toner images from the respective color photosensitive drums 1Y through 1K onto the intermediate transfer belt 6 has been described in the first embodiment described above, the present invention is not limited to such configuration. For instance, the invention is applicable also to a direct transfer type image forming apparatus directly transferring the respective color toner images from the respective photosensitive drums 1Y through 1K to the recording medium P. FIG. 8 illustrates a schematic configuration of the image forming apparatus according to the second embodiment of the present invention. The image forming apparatus 200 shown in FIG. 8 is a tandem direct transfer type full-color printer in which a plurality of image forming portions UY, UM, UC, and UK is disposed along a recording medium conveying belt 40.

In the image forming portion UY, a yellow toner image is formed on the photosensitive drum 1Y and is transferred onto a recording medium P (sheet member such as a sheet of paper, an OHP sheet, or the like) carried and conveyed by the recording medium conveying belt 40, i.e., a recording medium conveying member. In the image forming portion UM, a magenta toner image is formed on the photosensitive drum 1M and is transferred onto the recording medium P carried and conveyed by the recording medium conveying belt 40. In the same manner, in the image forming portions UC and UK, cyan and black toner images are formed on the photosensitive drums 1C and 1K and are transferred onto the recording medium P carried and conveyed by the recording medium conveying belt 40.

The recording medium P onto which the four color toner image has been transferred is self-stripped and is sent to the fixing unit 30. The recording medium P undergoes heat and pressure in the fixing unit 30 to fix the toner image and is then discharged out of the apparatus.

The image forming portions UY, UM, UC, and UK are constructed substantially in the same manner except that the colors of toners used in developing units 4Y, 4M, 4C, and 4K are different as yellow, magenta, cyan, and black. Accordingly, the image forming portion UY of yellow will be typically described in the following description, and the other image forming portions UM, UC, and UK will be described by replacing Y, i.e., a subscript of the reference sign, with M, C, and K.

The image forming portion UY includes a primary charger 2Y, an exposure unit 3Y, a developing unit 4Y, a transfer charger 5Y, and a drum cleaning unit 11Y respectively disposed around the photosensitive drum 1Y, i.e., an image bearing member. The photosensitive drum 1Y includes a photosensitive layer formed on an outer circumferential surface of a cylinder made of aluminum and rotates in a direction of an arrow R1 in FIG. 8 with a predetermined processing speed.

The primary charger 2Y charges the photosensitive drum 1Y with homogeneous negative dark part potential by irradiating charged particles generated by corona discharge for example. The exposure unit 3Y generates a laser beam, in which scan line image data obtained by developing a color separation image of each color is ON-OFF modulated, and scans the laser beam by a rotating mirror to form an electrostatic latent image on the charged photosensitive drum 1Y. The developing unit 4Y supplies toner to the photosensitive drum 1Y to develop the electrostatic latent image as a toner image.

The transfer charger 5Y includes a transfer blade and forms a transfer portion T1 of the toner image between the photosensitive drum 1Y and the recording medium conveying belt 40 by pressing the transfer blade to the recording medium conveying belt 40. A primary transfer bias power source 7Y, i.e., a primary bias applying portion, applies a transfer bias to the transfer charger 5Y. By applying a DC voltage of reverse polarity from charge polarity of the toner, the toner image born on the photosensitive drum 1Y is transferred onto the recording medium P on the recording medium conveying belt 40. So-called transfer residual toner left while being born on the photosensitive drum 1Y after the transfer is removed by the cleaning unit 11Y.

The image forming apparatus 200 includes a control portion 10. The control portion 10 executes the image density adjusting control shown in FIG. 3. However, in the case of the direct transfer type image forming apparatus 200, first and second patches (and third and fourth patches) are transferred, not onto the recording medium P, but onto the recording medium conveying belt 40. The density detecting sensors 17Y through 17K detect densities of these patches transferred onto the recording medium conveying belt 40. Then, the control portion 10 obtains the densities of these patches transferred onto the recording medium conveying belt 40 from the density detecting sensors 17Y through 17K and determines whether or not the non-electrostatic adhesion has been generated in the toner based on comparison of these densities (Steps S3 through S18 in FIG. 3). If the control portion 10 determines that the non-electrostatic adhesion has been generated in the toner, the control portion 10 controls the transfer bias power source 7Y such that the transfer bias applied to the transfer charger 5Y increases. Thereby, a defective image is hardly generated by the toner whose non-electrostatic adhesion has increased also in the case of the direct transfer type image forming apparatus 200.

It is noted that in the case of the direct transfer type image forming apparatus 200 shown in FIG. 8, a transfer body forming a transfer portion transferring a toner image formed on an image bearing member with the image bearing member in contact with the image bearing member is composed of the recording medium conveying belt 40. Still further the density detecting sensors 17K and 17C detecting the densities of the patches formed by the photosensitive drums 1K and 1C (see FIG. 1) are disposed on an end side of the recording medium conveying belt 40. In other words, the photosensitive drums 1K and 1C located on the side close to the fixing unit 30 (downstream in a rotation direction of the recording medium conveying belt 40) form the patches on the edge part of the recording medium conveying belt 40. The photosensitive drums 1M and 1Y located far from the fixing unit 30 (upstream in the rotation direction of the recording medium conveying belt 40) form the patches on a center part of the recording medium conveying belt 40. It is because the non-electrostatic adhesion of the toner is liable to increase by being affected by heat from the fixing unit 30 (see FIG. 1) on the photosensitive drums 1K and 1C located downstream in the rotation direction of the recording medium conveying belt 40.

### Other Embodiments

It is noted that while the density of the second patch previously formed is compared with the density of a second patch (fourth patch) formed this time in the case when the density of the third patch is lower than the range of the target density in the embodiment described above (see Steps S12 and S13 in FIG. 3), the present invention is not limited to such configuration. For instance, it may be configured so as to compare the second patch with the fourth patch in a case when the density of the third patch is less than the density of the first patch. Or, it may be also configured to compare the second patch with the fourth patch in a case when a difference of densities of the first and third patches is within a predetermined range after comparing the densities of the first and third patches.

It is noted that while the embodiment described above is configured such that the control portion 10 turns OFF the transfer high-voltage compensation, if it has been already ON (see Step S2 in FIG. 3), in the case when the predetermined time or more has elapsed since the end of the previous image forming job, the present invention is not limited to such configuration. For instance, it is configured such that the control portion 10 turns OFF the transfer high-voltage compensation, if it has been already ON, in a case where temperature detected by the temperature detecting sensors 31Y through 31K is higher than predetermined temperature or more. That is, because it is not necessary to turn ON the transfer high-voltage compensation in a state in which the apparatus body is cooled down, i.e., in which the transfer is less influenced by the non-electrostatic adhesion of the toner, the transfer high-voltage compensation is turned OFF if it has been already ON.

It is also noted that while the transfer high-voltage compensation is turned ON/OFF by controlling the primary transfer bias of the primary transfer bias power source 7Y in the embodiment described above, the present invention is not limited to such configuration. For instance, the transfer high-voltage compensation may be turned ON or OFF by controlling the secondary transfer bias of the secondary transfer bias power source 28. In such a case, the control of the primary transfer bias power source 7Y may be executed together with the control of the secondary transfer bias power source 28 or the transfer high-voltage compensation may be turned ON/OFF by just controlling the secondary transfer bias power source 28. For example, transfer electric field strength of the secondary transfer portion T2 may be increased by flowing a secondary transfer current by increasing a current vale (turning ON the transfer high-voltage compensation) from 65 to 70 μA (the transfer current A) to 75 to 80 μA (the transfer current B).

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-190919, filed Sep. 19, 2014 which is hereby incorporated by reference herein in its entirety.

What is claimed is:

1. An image forming apparatus, comprising:
an image bearing member;
a charging portion charging the image bearing member;
an exposure portion exposing the charged image bearing member to form an electrostatic latent image;
a developing portion developing the electrostatic latent image formed on the image bearing member by toner by applying a developing bias;
a transfer body forming a transfer portion, transferring a toner image formed on the image bearing member, with the image bearing member by being in contact with the image bearing member;
a transfer bias applying portion applying a transfer bias to the transfer portion;
a density detecting portion detecting density of the toner image on the transfer body; and
a control portion executing:
a first mode of forming a first adjustment toner image and a second adjustment toner image whose density is lower than that of the first adjustment toner image on the image bearing member, and of detecting the densities of the first and second adjustment toner images transferred to the transfer body, and
a second mode of forming a third adjustment toner image and a fourth adjustment toner image after executing the first mode and forming a predetermined number of images in a case where the density of the first adjustment toner image detected in the first mode is lower than a reference density, and of detecting densities of the third and fourth adjustment toner images transferred to the transfer body,
wherein the control portion forms the third adjustment toner image by increasing a development contrast, which is a potential difference between an exposure potential of the image bearing member exposed by the exposure portion and the developing bias, more than that generated in the case that the first adjustment toner image has been formed, and forms the fourth adjustment toner image in a same image forming condition with that of the second adjustment toner image, and
wherein the control portion increases the transfer bias in a case where certain conditions are met more than that in a case where those conditions are not met where the certain conditions are:
the density of the third adjustment toner image detected in the second mode being lower than the reference density,
the density of the fourth adjustment toner image being less than a predetermined value, and
a difference of the densities of the second and fourth adjustment toner images falling within a predetermined range.

2. The image forming apparatus according to claim 1, wherein the control portion lowers the transfer bias before executing the first mode in a case where the transfer bias has been increased in executing the previous image forming job and a predetermined time has elapsed since an end of the previous image forming job.

3. The image forming apparatus according to claim 1, further comprising a temperature detecting portion detecting temperature of the transfer portion;
wherein the control portion lowers the transfer bias before executing the first mode in a case where the transfer bias has been increased in executing the previous image forming job and detected temperature of the transfer portion is lower than predetermined temperature.

4. The image forming apparatus according to claim 1, further comprising a storage portion storing a first table setting a first control value corresponding to density of the toner image formed on the transfer body and a second table setting a second control value, which is greater than the first control value, corresponding to density of the toner image formed on the transfer body;
wherein the control portion controls the transfer bias applying portion to apply a transfer bias corresponding to a second control value of the second table in a case where the certain conditions are met based on density of the fourth adjustment toner image and controls the transfer bias applying portion to apply a transfer bias corresponding to a first control value of the first table in a case where the condition are not met.

5. The image forming apparatus according to claim 4, wherein the control portion controls the transfer bias applying portion to increase the transfer bias stepwise from the first control value to the second control value when the certain conditions are met and in increasing the transfer bias.

6. The image forming apparatus according to claim 1, wherein the transfer body is an intermediate transfer body forming a primary transfer portion as the transfer portion with the image bearing member by being in contact with the image bearing member and onto which the toner image formed on the image bearing member is primarily transferred in the primary transfer portion, and
wherein the transfer bias applying portion is a primary bias applying portion applying a primary transfer bias to the primary transfer portion.

7. The image forming apparatus according to claim 6, further comprising a secondary transfer member forming a secondary transfer portion with the intermediate transfer body by being in contact with the intermediate transfer body and the toner image primarily transferred onto the intermediate transfer body is secondarily transferred to a recording medium in the secondary transfer portion; and
a secondary bias applying portion applying a secondary transfer bias to the secondary transfer portion,
wherein the control portion increases the secondary transfer bias in the case where the certain conditions are met more than the case where the certain conditions are not met.

8. The image forming apparatus according to claim 7, further comprising a fixing portion fixing the toner image onto the recording medium by heating the recording medium on which the toner image has been secondarily transferred,
wherein the image bearing member is disposed plurality along a rotation direction of the intermediate transfer body, and
wherein a first image bearing member disposed on a side close to the fixing portion among the plurality of image bearing members forms the first through fourth adjustment toner images on edge sides of the intermediate transfer body more than a second image bearing member disposed on a side far from the fixing portion.

9. The image forming apparatus according to claim 1, wherein the transfer body is a recording medium conveying member carrying and conveying a recording medium; and
wherein a toner image formed on the image bearing member is transferred onto the recording medium at the transfer portion.

10. An image forming apparatus, comprising:
an image bearing member;
a charging portion charging the image bearing member;
an exposure portion exposing the charged image bearing member to form an electrostatic latent image;
a developing portion developing the electrostatic latent image formed on the image bearing member by toner by applying a developing bias;
a transfer body forming a transfer portion transferring a toner image formed on the image bearing member with the image bearing member by being in contact with the image bearing member;
a transfer bias applying portion applying a transfer bias to the transfer portion;
a density detecting portion detecting density of the toner image on the transfer body; and
a control portion executing:
a first mode of forming a first adjustment toner image and a second adjustment toner image whose density is lower than that of the first adjustment toner image on the image bearing member, and of detecting the densities of the first and second adjustment toner images transferred to the transfer body, and
a second mode of forming a third adjustment toner image and a fourth adjustment toner image after executing the first mode and forming a predetermined number of images in a case where the density of the first adjustment toner image detected in the first mode is lower than a reference density, and of detecting densities of the third and fourth adjustment toner images transferred to the transfer body,
wherein the control portion forms the third adjustment toner image by increasing a development contrast, which is a potential difference between an exposure potential of the image bearing member exposed by the exposure portion and the developing bias, more than that generated in the case that the first adjustment toner image has been formed, and forms the fourth adjustment toner image in a same image forming condition with that of the second adjustment toner image, and
wherein the control portion increases the transfer bias in a case where certain conditions are met more than that in a case where those conditions are not met where the certain conditions are:
the density of the third adjustment toner image detected in the second mode being lower than the density of the first adjustment toner image or a difference of the densities of the first and third adjustment toner images falling within a predetermined range,
the density of the fourth adjustment toner image being less than a predetermined value, and
a difference of the densities of the second and fourth adjustment toner images falling within a predetermined range.
